(19) United States
(12) Patent Application Publication
(10) Pub. No.: US 2026/0211601 A1
(43) Pub. Date: Jul. 23, 2026

(54) DISPLAY SYSTEM AND DISPLAY METHOD

(71) Applicant: SEIKO EPSON CORPORATION, Tokyo (JP)

(72) Inventor: Toshiaki HONDA, BEPPU-SHI (JP)

(21) Appl. No.: 19/456,017

(22) Filed: Jan. 22, 2026

(30) Foreign Application Priority Data
Jan. 23, 2025 (JP) 2025-009684

(51) Int. Cl. G06F 3/14; H04N 9/31

(52) U.S. Cl. CPC G06F 3/14; H04N 9/3105; H04N 9/3179

(57) ABSTRACT

According to an aspect of the present disclosure, there is provided a display system in which one or a plurality of processors execute causing a display device to display a setting image including a first image for receiving an answer for permitting a display request by a first terminal device, a second image for receiving an answer for rejecting the display request by the first terminal device, and a third image for receiving an answer for adding an identifier of the first terminal device to a list for rejecting the display request and rejecting connection between the first terminal device and the display device without displaying the setting image when a connection request has been received from the first terminal device after the third image was selected.

The present application is based on, and claims priority from JP Application Serial Number 2025-009684, filed January 23, 2025, the disclosure of which is hereby incorporated by reference herein in its entirety.

### BACKGROUND

### 1. Technical Field

The present disclosure relates to a display system and a display method.

### 2. Related Art

JP-A-2005-208823 discloses a system including a projector, a host information terminal device that transmits image data to the projector, and a client information terminal device other than the host information terminal device. Here, users of the host information terminal device and the client information terminal device can establish a network with the projector and transmit appropriate image data to the projector by inputting, with operation of a keyboard or a mouse, a password projected onto a screen and a unique code of the projector.

JP-A-2005-208823 is an example of the related art.

In the system described in JP-A-2005-208823, a technique of performing operation of permitting or rejecting communication connection between the projector and the client information terminal device using the host information terminal device or the projector and controlling appropriate communication between the projector and the client information terminal device is well-known. However, in the related art, for example, when it is desired to continuously reject the communication connection with the client information terminal device, it is necessary to perform the rejecting operation step by step, which is inconvenient.

### SUMMARY

According to an aspect of the present disclosure, there is provided a display system including: a first terminal device; a display device communicably connected to the first terminal device and configured to display an image based on image data supplied from the first terminal device; and one or a plurality of processors, wherein the one or the plurality of processors execute: causing the display device to display a setting image including a first image for receiving an answer for permitting a display request by the first terminal device, a second image for receiving an answer for rejecting the display request by the first terminal device, and a third image for receiving an answer for adding an identifier of the first terminal device to a list for rejecting the display request; and rejecting connection between the first terminal device and the display device without displaying the setting image when a connection request was received from the first terminal device after the third image was selected.

According to an aspect of the present disclosure, there is provided a display method including: causing, with one or a plurality of processors, a display device communicably connected to a first terminal device to display a setting image including a first image for receiving an answer for permitting a display request by the first terminal device, a second image for receiving an answer for rejecting the display request by the first terminal device, and a third image for receiving an answer for adding an identifier of the first terminal device to a list for rejecting the display request; and rejecting, with the one or the plurality of processors, connection between the first terminal device and the display device without displaying the setting image when a connection request was received from the first terminal device after the third image was selected.

### BRIEF DESCRIPTION OF THE DRAWINGS

FIG. 1 is a perspective view illustrating a display system according to an embodiment.

FIG. 2 is a block diagram of a projector used in the display system according to the embodiment.

FIG. 3 is a flowchart of a display method according to the embodiment.

FIG. 4 is a flowchart of the display method according to the embodiment.

FIG. 5 is a diagram illustrating an example of a setting image.

FIG. 6 is a diagram illustrating a setting image in the case in which a connection request of another terminal device has been received after connection permission.

FIG. 7 is a diagram illustrating a projection image in the case in which the connection request of the other terminal device has been permitted after the connection permission.

### DESCRIPTION OF EMBODIMENTS

A preferred embodiment according to the present disclosure is hereinafter explained with reference to the accompanying drawings. Note that, in the drawings, dimensions and scales of units are different from actual ones as appropriate and some portions are schematically illustrated in order to facilitate understanding. The scope of the present disclosure is not limited to the embodiment unless there is particularly a description to the effect that the present disclosure is limited in the following explanation.

### 1. Embodiment

### 1-1. Overview of a display system

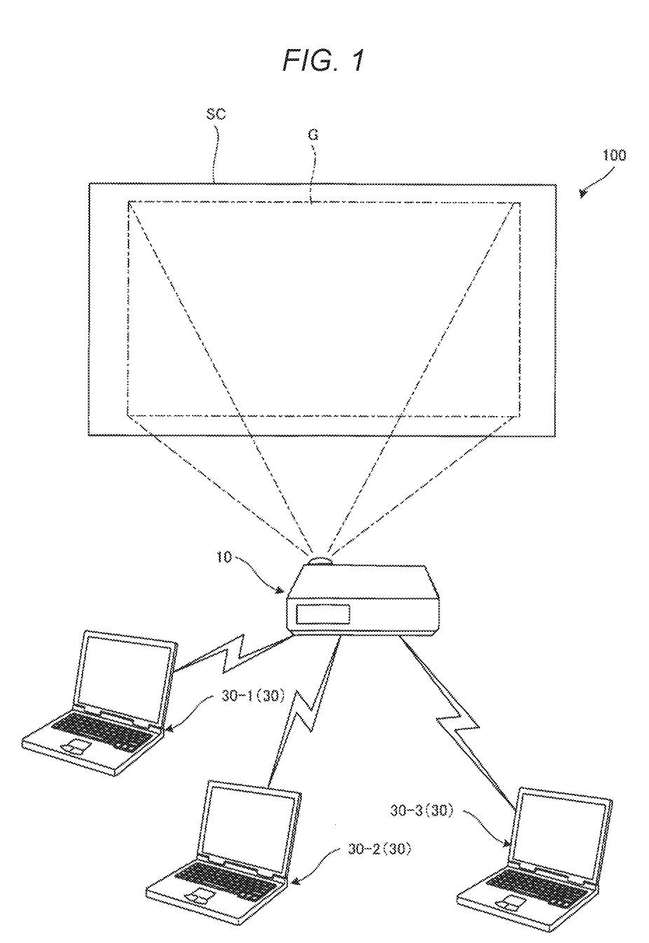

FIG. 1 is a perspective view illustrating a display system 100 according to an embodiment. The display system 100 is a projection system including a projector 10 that projects an image G onto a projection surface SC. The projection surface SC is a projection target and is specifically a surface of an object such as a screen. In an example illustrated in FIG. 1, the projection surface SC is a planar surface. The projection surface SC is not limited to the planar surface and may be, for example, a curved surface.

The display system 100 includes a plurality of terminal devices 30 besides the projector 10. In the example illustrated in FIG. 1, the display system 100 includes a first terminal device 30-1, a second terminal device 30-2, and a third terminal device 30-3 as the terminal devices 30. The number of terminal devices 30 provided in the display system 100 is not limited to the illustrated example and is optional and may be two or may be four or more. Hereinafter, when the first terminal device 30-1, the second terminal device 30-2, and the third terminal device 30-3 are not distinguished, each of the terminal devices is referred to as terminal device 30.

The projector 10 is a display device that projects, onto the projection surface SC, an image G indicated by image data DG explained below output from the terminal device 30. The projector 10 has a function of displaying a setting image GUI explained below capable of selecting whether to permit a display request when receiving a connection request of the terminal device 30 and a function of disconnecting from the terminal device 30 that has rejected the display request. In particular, the projector 10 has a function capable of, in selection of rejecting the display request, adding, to a list, an identifier of the terminal device 30 that is a target for which the display request is rejected and, when the connection request of the terminal device 30 added to the list has been received again, disconnects from the terminal device 30 without displaying the setting image GUI explained below.

The terminal device 30 is a device having a function of supplying the image data DG explained below to the projector 10. In the example illustrated in FIG. 1, the terminal device 30 is a laptop computer. The terminal device 30 is not limited to the laptop computer and may be, for example, a desktop computer, a smartphone, or a tablet terminal or may be a video player, a digital versatile disk (DVD) player, a Blu-ray disc player, a hard disk recorder, a television tuner, a set-top box for a cable television (CATV), or a video game machine.

### 1-2. Projector

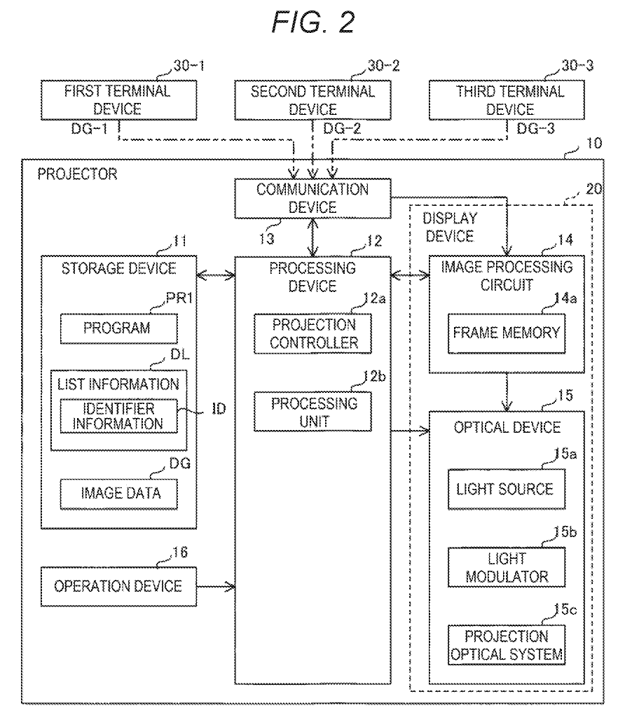

FIG. 2 is a block diagram of the projector 10 used in the display system 100 according to the embodiment. As illustrated in FIG. 2, the projector 10 includes a storage device 11, a processing device 12, a communication device 13, an image processing circuit 14, an optical device 15, and an operation device 16. These devices are communicably connected to each other. The processing device 12 is an example of "one or a plurality of processors". The image processing circuit 14 and the optical device 15 configure a display device 20.

The display device 20 is communicably connected to the terminal device 30 and displays an image based on the image data DG supplied from the terminal device 30. In FIG. 2, the image data DG supplied from the first terminal device 30-1 is described as image data DG-1, the image data DG supplied from the second terminal device 30-2 is described as image data DG-2, and the image data DG supplied from the third terminal device 30-3 is described as image data DG-3. Hereinafter, when the image data DG-1, DG-2, and DG-3 are not distinguished, each of the image data DG- 1, DG-2, and DG-3 is sometimes referred to as image data DG.

The storage device 11 is a storage device that stores programs to be executed by the processing device 12 and data to be processed by the processing device 12. The storage device 11 includes, for example, a hard disk drive or a semiconductor memory. Note that a part or the entire storage device 11 may be provided in a storage device on the outside of the projector 10, a server, or the like.

A program PR1, image data DG, and list information DL are stored in the storage device 11.

The program PR1 is a program for executing a display method explained below. The image data DG is information indicating the image G that should be projected onto the projection surface SC. The list information DL is information indicating a list of the terminal devices 30 to be rejected to be connected to the projector 10 and includes identifier information ID. The identifier information ID is information indicating an identifier of the terminal device 30 to be rejected to be connected to the projector 10. The identifier is, for example, an IP address or an individual number of the terminal device 30. Since a MAC address of the terminal device 30 is randomized and thus does not have persistence, the MAC address is unsuitable as the identifier.

The processing device 12 is a processing device having a function of controlling the units of the projector 10 and a function of processing various data. The processing device 12 includes at least one processor such as a central processing unit (CPU). The processing device 12 may include a single processor or may include a plurality of processors. Some or all of the functions of the processing device 12 may be implemented by hardware such as a digital signal processor (DSP), an application specific integrated circuit (ASIC), a programmable logic device (PLD), or a field programmable gate array (FPGA) . The processing device 12 may be integrated with the image processing circuit 14.

The communication device 13 is a communication device capable of communicating with various types of equipment and acquires the image data DG from the terminal device 30. For example, the communication device 13 is a wired communication device of a wired local area network (LAN), a universal serial bus (USB), a high definition multimedia interface (HDMI), or the like or a wireless communication device of a low power wide area (LPWA), a wireless LAN including Wi-Fi, Bluetooth, or the like. Each of "HDMI", "Wi-Fi", and "Bluetooth" is a registered trademark.

The image processing circuit 14 is a circuit that performs necessary processing on the image data DG received from the communication device 13 and inputs the image data DG to the optical device 15. The image processing circuit 14 includes a frame memory 14a, loads the image data DG in the frame memory 14a, and inputs the image data DG to the optical device 15 after executing various kinds of processing such as resolution conversion processing, resize processing, and distortion correction processing on the image data DG as appropriate. The image processing circuit 14 executes, according to necessity, processing such as OSD (On Screen Display) processing of generating image information for menu display, operation guide, or the like including the setting image GUI explained below and combining the image information with the image data DG. As explained above, the display device 20 includes the frame memory 14a that temporarily saves the image data DG.

The optical device 15 is a device that projects image light onto the projection surface SC. The optical device 15 includes a light source 15a, a light modulator 15b, and a projection optical system 15c.

The light source 15a includes a light source such as a halogen lamp, a xenon lamp, an ultrahigh-pressure mercury lamp, a light emitting diode (LED), or a laser light source and outputs red light, green light, and blue light. The light modulator 15b draws the image G based on the image data DG supplied from the terminal device 30. The light modulator 15b includes three light modulation elements provided to correspond to red, green, and blue. The light modulation elements include, for example, transmissive liquid crystal panels, reflective liquid crystal panels, or digital mirror devices (DMDs) and modulate lights of colors corresponding thereto to generate image lights of the colors. The image lights of the colors generated by the light modulator 15b are combined by a color combination optical system to be full color image light. The projection optical system 15c is an optical system including a projection lens that forms an image of the full color image light emitted from the light modulator 15b and projects the image onto the projection surface SC. An image drawn by the light modulator 15b, that is, a drawn image is projected onto the projection surface SC via the projection lens.

The operation device 16 is a device that receives operation of a user. For example, the operation device 16 includes an operation panel and a remote controller light receiver, both of which are not illustrated in the figures. The operation panel is provided in an exterior housing of the projector 10 and outputs a signal based on operation of the user. The remote controller light receiver receives an infrared signal from a not-illustrated remote controller, decodes the infrared signal, and outputs a signal based on operation on the remote controller. Note that the operation device 16 is provided according to necessity and a part of the operation device 16 may be omitted.

In the projector 10 explained above, the processing device 12 executes the program PR1 stored in the storage device 11 to thereby function as a projection controller 12a and a processing unit 12b. Therefore, the processing device 12 includes the projection controller 12a and the processing unit 12b.

The projection controller 12a controls operations of the image processing circuit 14 and the optical device 15 to thereby project the image G onto the projection surface SC. The projection controller 12a causes the display device 20 to display the setting image GUI explained below.

The processing unit 12b permits or rejects a connection request for the terminal device 30 to the projector 10 and generates the list information DL based on operation on the setting image GUI explained below. The processing unit 12b rejects the connection request for the terminal device 30 to the projector 10 based on the list information DL.

### 1-3. Display method

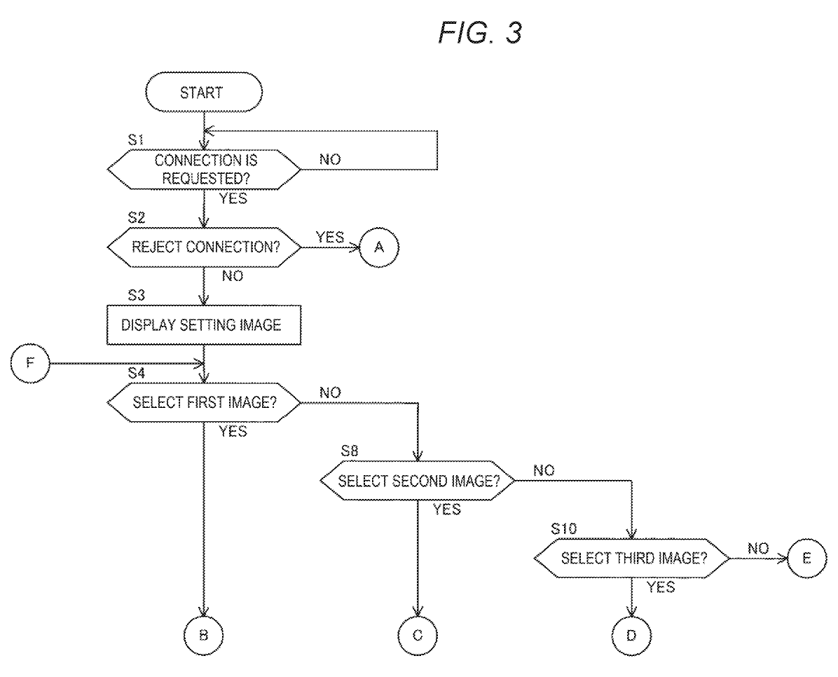

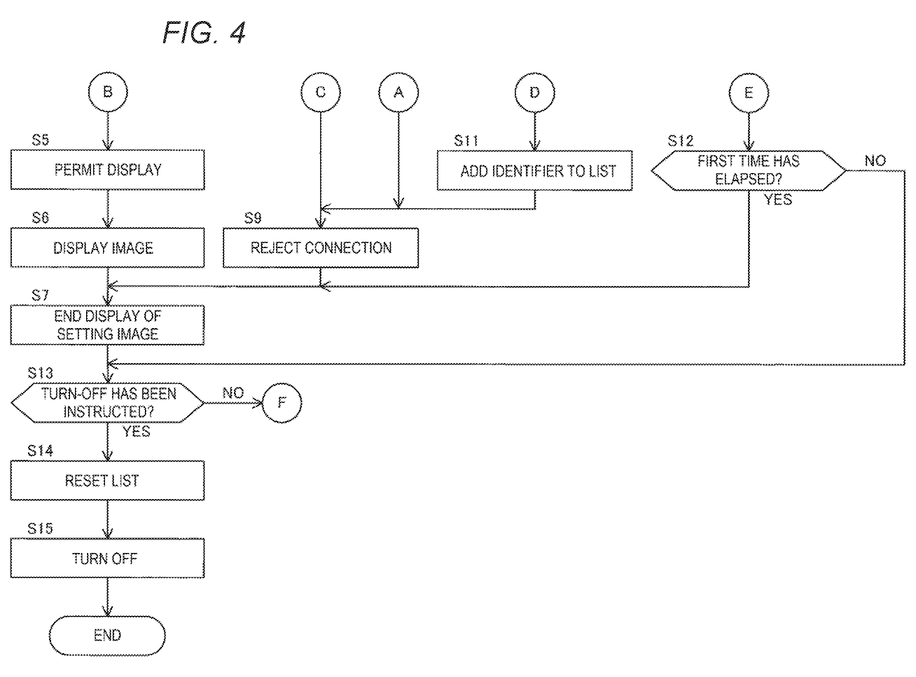

FIGS. 3 and 4 are flowcharts of a display method according to the embodiment. The display method includes steps S1 to S15 as illustrated in FIGS. 3 and 4. These steps are executed by the processing device 12. Overviews of the steps are explained below.

In step S1, the processing device 12 functioning as a processing unit 12b determines the presence or absence of a connection request of the terminal device 30. Step S1 is repeatedly executed until the communication device 13 receives a connection request of any one of the terminal devices 30 (step Sl: NO).

When the communication device 13 has received a connection request of any one of the terminal devices 30 (step Sl: YES), in step S2, the processing device 12 functioning as the processing unit 12b determines whether to reject the received connection request. This determination is made according to whether an identifier included in the received connection request coincides with an identifier indicated by the identifier information ID included in the list information DL. When the identifier included in the received connection request coincides with the identifier indicated by the identifier information ID included in the list information DL, the processing device 12 determines to reject the received connection request (step S2: YES). In this case, the processing device 12 functioning as the processing unit 12b shifts to step S9 explained below and rejects connection to the terminal device 30 corresponding to the received connection request. On the other hand, when the identifier included in the received connection request does not coincide with the identifier indicated by the identifier information ID included in the list information DL, the processing device 12 determines not to reject the received connection request (step S2: NO).

Since the list information DL is reset when the projector 10 is turned off in step S14 explained below, the identifier indicated by the identifier information ID included in the list information DL is absent at the time of execution of first step S2 after the projector 10 is turned on. Therefore, the processing device 12 shifts to step S3 without rejecting the received connection request.

When not to reject the received connection request (step S2: NO), in step S3, the processing device 12 functioning as the projection controller 12a causes the display device 20 to display the setting image GUI explained below. Here, the processing device 12 controls the operations of the image processing circuit 14 and the optical device 15 to thereby project an image including the setting image GUI explained below onto the projection surface SC.

After step S3, in step S4, the processing device 12 functioning as the processing unit 12b determines whether operation of selecting a first image G1 explained below included in the setting image GUI explained below has been performed. This determination is made based on the presence or absence of operation on the first image G1 performed using the operation device 16.

When the first image G1 has been selected (step S4: YES), in step S5, the processing device 12 functioning as the processing unit 12b permits display on the terminal device 30 corresponding to the received connection request.

After step S5, in step S6, the processing device 12 functioning as the projection controller 12a causes the display device 20 to display the image G based on the image data DG supplied from the terminal device 30 on which the display has been permitted. Here, the processing device 12 controls the operations of the image processing circuit 14 and the optical device 15 to thereby project, onto the projection surface SC, the image G based on the image data DG supplied from the terminal device 30 on which the display has been permitted.

After step S6, in step S7, the processing device 12 functioning as the projection controller 12a causes the display device 20 to end the display of the setting image GUI explained below. Here, the processing device 12 controls the operations of the image processing circuit 14 and the optical device 15 to end the projection of the setting image GUI explained below onto the projection surface SC.

On the other hand, when the first image G1 has not been selected (step S4: NO), in step S8, the processing device 12 functioning as the processing unit 12b determines whether operation of selecting a second image G2 explained below included in the setting image GUI explained below has been performed. This determination is made based on the presence or absence of operation on the second image G2 performed using the operation device 16.

When the second image G2 has been selected (step S8: YES), in step S9, the processing device 12 functioning as the processing unit 12b rejects connection to the terminal device 30 corresponding to the received connection request. As a result, the display on the terminal device 30 corresponding to the received connection request is rejected. After step S9, the processing device 12 shifts to step S7 explained above.

On the other hand, when the second image G2 has not been selected (step S8: NO), in step 510, the processing device 12 functioning as the processing unit 12b determines whether operation of selecting a third image G3 explained below included in the setting image GUI explained below has been performed. This determination is made based on the presence or absence of operation on the third image G3 performed using the operation device 16.

When the third image G3 has been selected (step S10: YES), in step S11, the processing device 12 functioning as the processing unit 12b adds an identifier of the terminal device 30 corresponding to the received connection request to the list indicated by the list information DL as the identifier information ID and thereafter shifts to step S9 explained above. Accordingly, in step S9, when the connection request has been received from the first terminal device 30-1 after the third image G3 was selected, the processing device 12 rejects connection between the first terminal device 30-1 and the display device 20 without displaying the setting image GUI.

On the other hand, when the third image G3 has not been selected (steps S10: NO), in step S12, the processing device 12 functioning as the processing unit 12b determines whether a first time, which is a predetermined time, has elapsed from the start of the display of the setting image GUI. The length of the first time is not particularly limited but is, for example, approximately several tens of seconds and may be optionally set or changed by the user.

When the first time has elapsed (step S12: YES),the processing device 12 functioning as the processing unit 12b shifts to step S7 explained above. Accordingly, even if the setting image GUI has not been selected, when the setting image GUI has been displayed for the first time, the display of the setting image GUI ends.

As explained above, after the first time has elapsed from the start of the display of the setting image GUI (step S12: YES), in step S7, the processing device 12 causes the display device 20 to end the display of the setting image GUI. Accordingly, since the user does not need to perform operation of ending the display of the setting image GUI, the convenience is further improved.

On the other hand, when the first time has not elapsed (step S12: NO) or after step S7, in step S13, the processing device 12 functioning as the processing unit 12b determines the presence or absence of an instruction to turn off the projector 10. This determination is made based on the presence or absence of operation on a not-illustrated power switch of the projector 10.

When there is no instruction to turn off theprojector 10 (stepS13: NO), the processing device 12 functioning as the processing unit 12b returns to step S4 explained above. Accordingly, the setting image GUI is displayed until operation on the setting image GUI is performed or the first time elapses.

When there is an instruction to turn off the projector 10 (step S13: YES), in step S14, the processing device 12 functioning as the processing unit 12b resets the list indicated by the list information DL. This reset is performed, for example, by erasing the identifier information ID included in the list information DL.

As explained above, in step S14, the processing device 12 resets the list when the display device 20 has been turned off. Accordingly, since it is unnecessary to separately manually perform work of resetting the list, the convenience is further improved.

After step S14, in step S15, the processing device 12 turns off the projector 10 and thereafter ends the processing.

### 1-4. Setting image

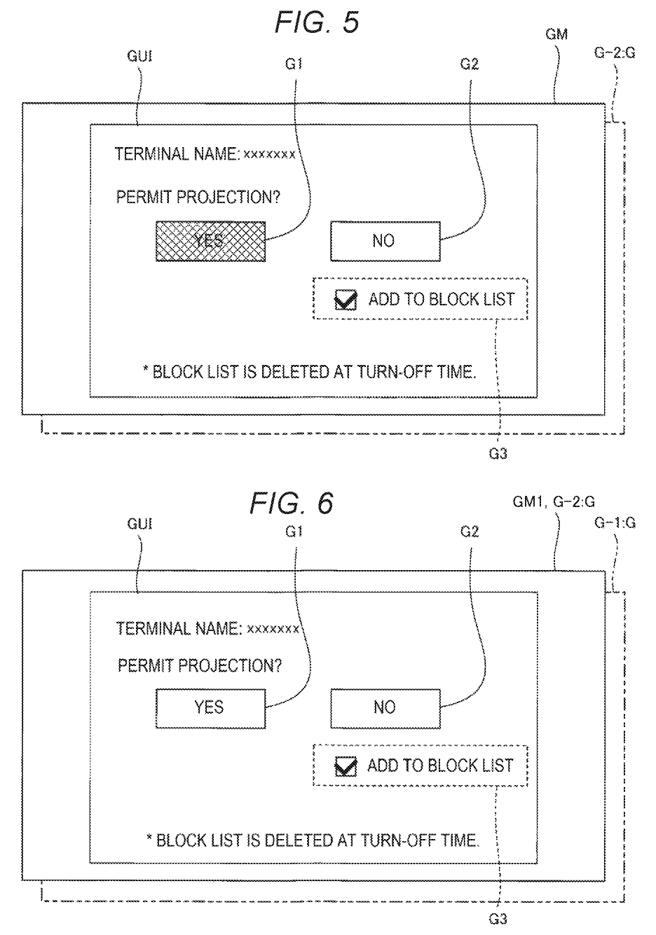

FIG. 5 is a diagram illustrating an example ofthe setting image GUI. In FIG. 5, an image GM including the setting image GUI in the case in which the projector 10 has received a connection request from the second terminal device 30-2 serving as the first terminal device 30 after the projector 10 was turned on is illustrated.

In step S3, as illustrated in FIG. 5, the image GM including the setting image GUI is projected onto the projection surface SC. The image GM is, for example, an image generated by OSD processing. A portion of the image GM other than the setting image GUI is a mask image for masking the image G based on the image data DG loaded in the frame memory 14a. Therefore, even when the image data DG-2 from the second terminal device 30-2 requesting connection is loaded in the frame memory 14a, an image G-2 based on the image data DG-2 is masked as a lower layer by the image GM serving as an upper layer. Accordingly, the image G-2 is not displayed on the projection surface SC.

As explained above, in step S3, in a state in which the image data DG is loaded in the frame memory 14a, the processing device 12 causes the display device 20 to display the setting image GUI. Accordingly, when connection between the terminal device 30 and the display device 20 has been permitted, the display device 20 can quickly display the image G based on the image data DG thereafter.

At the time of executing first step S3 after the projector 10 was turned on, since display requests of all the terminal devices 30 are not permitted, the portion of the image GM other than the setting image GUI is an image for masking based on data other than the image data DG.

The setting image GUI is a graphical user interface (GUI) image for setting whether to permit a connection request for the terminal device 30 to the projector 10 and is capable of receiving operation performed by the user using the operation device 16. The setting image GUI includes the first image G1, the second image G2, and the third image G3.

In the example illustrated in FIG. 5, besides the first image G1, the second image G2, and the third image G3, the image GM includes a terminal name of the terminal device 30 requesting connection, characters "Permit projection?" serving as display for urging operation of the first image G1, the second image G2, or the third image G3 explained below, and display indicating that the list information DL is reset in step S14. A display mode of the image GM is not limited to the illustrated example and is optional.

The first image G1 is an image for receiving an operated, in step S4, the processing device 12 determines that the first image G1 has been selected. A display form of the first image G1 is not limited to the example illustrated in FIG. 5 and is optional. answer for permitting a display request by the terminal device 30 and is capable of receiving selection operation performed by the user using the operation device 16. In the example illustrated in FIG. 5, the first image G1 is a button for receiving operation of permitting a display request by the terminal device 30. When the button is operated, in step S4, the processing device 12 determines that the first image G1 has been selected. A display form of the first image G1 is not limited to the example illustrated in FIG. 5 and is optional.

The second image G2 is an image for receiving an answer for rejecting a display request by the terminal device 30 and is capable of receiving selection operation performed by the user using the operation device 16. In the example illustrated in FIG. 5, the second image G2 is a button for receiving operation of rejecting a display request by the terminal device 30. When the button is operated without a check box in the third image G3 explained below being checked, in step S8, the processing device 12 determines that the second image G2 has been selected. A display form of the second image G2 is not limited to the example illustrated in FIG. 5 and is optional.

The third image G3 is an image for receiving an answer for adding an identifier of the terminal device 30 to a list for rejecting a display request and is capable of receiving selection operation performed by the user using the operation device 16. In the example illustrated in FIG. 5, the third image G3 is a check box for receiving selection of whether to add an identifier of the terminal device 30 to the list for rejecting a display request. When the second image G2 is operated after the check box is checked, in step 510, the processing device 12 determines that the third image G3 has been selected. A display form of the third image G3 is not limited to the example illustrated in FIG. 5 and is optional. For example, the third image G3 may be a button for receiving operation of adding an identifier of the first terminal device 30-1 to the list for rejecting a display request.

In the setting image GUI explained above, when the first image G1 has been selected, as explained above, in step S5, the image G based on the image data DG supplied from the terminal device 30, a connection request of which has been permitted, is projected onto the projection surface SC.

On the other hand, when the second image G2 or the third image G3 has been selected, as explained above, in step S9, connection from the terminal device 30, a connection request of which has been permitted, is rejected.

Here, when the third image G3 has been selected, as explained above, in step S11, to reject a connection request of the terminal device 30, the connection request of which has been permitted, thereafter as well, the identifier information ID indicating an identifier of the terminal device 30 is added to the list information DL.

FIG. 6 is a diagram illustrating the setting image GUI in the case in which a connection request has been received from another terminal device 30 after connection permission. In FIG. 6, an image GM1 including the setting image GUI in the case in which a connection request of the first terminal device 30-1 has been received after connection permission for the second terminal device 30-2 is illustrated.

The image GM1 is the same as the image GM explained above except that portions other than the setting image GUI are different. When the connection request of the first terminal device 30-1 has been received after the connection permission for the second terminal device 30-2, the image G-2 based on the image data DG-2 supplied from the second terminal device 30-2 is used as an image for masking in a portion of the image GM1 other than the setting image GUI.

Here, even if the image data DG-1 supplied from the first terminal device 30-1 requesting connection is loaded in the frame memory 14a, the image G-1 based on the image data DG-1 is masked as a lower layer by the image GM1 serving as an upper layer. Accordingly, the image G-1 is not displayed on the projection surface SC.

For example, when a teacher gives a lecture to students using the projector 10 at an education site, it is possible to permit connection of not only the terminal device 30 owned by the teacher but also the terminal devices 30 owned by the students to the projector 10 according to necessary. It is also possible to prevent mischiefs and the like by the students without rejecting connection of the terminal devices 30 owned by the students every time. At this time, the teacher is an example of a "host" and the students are an example of a "guest".

When a connection request has been received from the first terminal device 30-1 after the third image G3 was selected, since connection between the first terminal device 30-1 and the display device 20 is rejected without the setting image GUI being displayed, it is unnecessary to select the second image G2 in the setting image GUI every time the connection request is received from the first terminal device 30-1 and the convenience is improved.

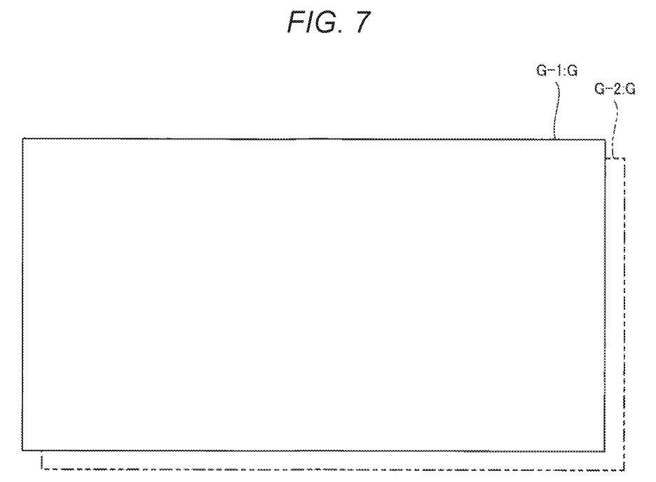

FIG. 7 is a diagram illustrating a projection image in the case in which a connection request of another terminal device 30 has been permitted after connection permission. In FIG. 7, the image G-1 projected onto the projection surface SC after execution of step S7 in the case in which a connection request of the first terminal device 30-1 has been permitted in the case illustrated in FIG. 6 is illustrated.

Here, the image G-2 based on the image data DG- 2 supplied from the second terminal device 30-2, a connection request of which has already been permitted, ismasked as a lower layer by the image G-1 serving as an upper layer. Accordingly, the image G-2 is not displayed on the projection surface SC but is retained in a state in which the image data DG-2 is loaded in the frame memory 14a. For this reason, it is possible to quickly switch a display state of the image G-1 to a display state of the image G-2.

### 2. Modifications

Although the display device and the display system of the present disclosure are explained above based on the illustrated embodiment, the present disclosure is not limited the embodiment. The configurations of the units of the present disclosure can be replaced by any configurations that exert the same functions as the functions in the embodiment explained above or any configurations can also be added.

In the embodiment explained above, it is basically assumed that the operation of selecting any one of the first image G1, the second image G2, and the third image G3 is performed by the host. However, the operation may be performed by the guest or may be performed by both of the host and the guest.

### 3. Appendixes

The present disclosure is summarized below as appendices.

(Appendix 1) According to a first aspect of the present disclosure, there is provided a display system including: a first terminal device; a display device communicably connected to the first terminal device and configured to display an image based on image data supplied from the first terminal device; and one or a plurality of processors, wherein the one or the plurality of processors execute: causing the display device to display a setting image including a first image for receiving an answer for permitting a display request by the first terminal device, a second image for receiving an answer for rejecting the display request by the first terminal device, and a third image for receiving an answer for adding an identifier of the first terminal device to a list for rejecting the display request; and rejecting connection between the first terminal device and the display device without displaying the setting image when a connection request was received from the first terminal device after the third image was selected.

In the above aspect, when the connection request has been received from the first terminal device after the third image was selected, the connection between the first terminal device and the display device is rejected without the setting image being displayed. Therefore, it is unnecessary to select the second image in the setting image every time the connection request is received from the first terminal device and convenience is improved.

(Appendix 2) In a second aspect that is a preferred example of the first aspect, the one or the plurality of processors reset the list when the display device was turned off. In the above aspect, since it is unnecessary to separately manually perform work of resetting the list, the convenience is further improved.

(Appendix 3) In a third aspect that is a preferred example of the first aspect or the second aspect, the display device includes a frame memory configured to temporarily save the image data, and the one or the plurality of processors cause the display device to display the setting image in a state in which the image data is loaded in the frame memory. In the above aspect, when the connection between the first terminal device and the display device has been permitted, the display device can quickly display an image based on image data thereafter.

(Appendix 4) In a fourth aspect that is a preferred example of any one of the first aspect to the third aspect, the one or the plurality of processors cause the display device to end the display of the setting image after a first time elapsed from a start of the display of the setting image. In the above aspect, since a user does not need to perform operation of ending the display of the setting image, the convenience is further improved.

(Appendix 5) According to a fifth aspect of the present disclosure, there is provided a display method including: causing, with one or a plurality of processors, a display device communicably connected to a first terminal device to display a setting image including a first image for receiving an answer for permitting a display request by the first terminal device, a second image for receiving an answer for rejecting the display request by the first terminal device, and a third image for receiving an answer for adding an identifier of the first terminal device to a list for rejecting the display request; and rejecting, with the one or the plurality of processors, connection between the first terminal device and the display device without displaying the setting image when a connection request was received from the first terminal device after the third image was selected.

In the above aspect, when the connection request has been received from the first terminal device after the third image was selected, the connection between the first terminal device and the display device is rejected without the setting image being displayed. Therefore, it is unnecessary to select the second image in the setting image every time the connection request is received from the first terminal device and convenience is improved.

What is claimed is:

1. A display system comprising:
a first terminal device;
a display device communicably connected to the first terminal device and configured to display an image based on image data supplied from the first terminal device; and
one or a plurality of processors, wherein the one or the plurality of processors execute:
causing the display device to display a setting image including a first image for receiving an answer for permitting a display request by the first terminal device, a second image for receiving an answer for rejecting the display request by the first terminal device, and a third image for receiving an answer for adding an identifier of the first terminal device to a list for rejecting the display request; and
rejecting connection between the first terminal device and the display device without displaying the setting image when a connection request was received from the first terminal device after the third image was selected.

2. The display system according to claim 1, wherein the one or the plurality of processors reset the list when the display device was turned off.

3. The display system according to claim 1, wherein
the display device includes a frame memory configured to temporarily save the image data, and
the one or the plurality of processors cause the display device to display the setting image in a state in which the image data is loaded in the frame memory.

4. The display system according to claim 1, wherein the one or the plurality of processors cause the display device to end the display of the setting image after a first time elapsed from a start of the display of the setting image.

5. A display method comprising:
causing, with one or a plurality of processors, a display device communicably connected to a first terminal device to display a setting image including a first image for receiving an answer for permitting a display request by the first terminal device, a second image for receiving an answer for rejecting the display request by the first terminal device, and a third image for receiving an answer for adding an identifier of the first terminal device to a list for rejecting the display request; and
rejecting, with the one or the plurality of processors, connection between the first terminal device and the display device without displaying the setting image when a connection request was received from the first terminal device after the third image was selected.
